(19) United States
(12) Patent Application Publication
(10) Pub. No.: US 2018/0346678 A1
(43) Pub. Date: Dec. 6, 2018

(54) BREATHABLE EARPIECES

(71) Applicant: Bose Corporation, Framingham, MA (US)

(72) Inventors: Shawn J. Prevoir, Northborough, MA (US); Caitlin Hanson, Tyngsboro, MA (US)

(21) Appl. No.: 15/607,798

(22) Filed: May 30, 2017

(51) Int. Cl. C08J 9/26; C08L 101/00; H04R 1/10

(52) U.S. Cl. CPC C08J 9/26; C08L 101/00; H04R 1/105; C08J 2201/0446; C08J 2300/26; C08J 2201/0424; C08J 2439/06; C08J 2429/04; C08J 2201/042; C08J 2201/0422

(57) ABSTRACT

The disclosure is related to compositions having water permeability greater than about 20 g/(hr*m²) that includes one or more elastomers and one or more agents and methods of preparing the same. The compositions are suitable for use in acoustical devices such as earpieces, e.g., in-ear earpieces.

### TECHNICAL FIELD

This disclosure generally relates to compositions that are useful for acoustical devices such as earpieces, methods of preparing the compositions.

### BACKGROUND

Earpieces can be e.g., part of earphones and other devices placed within human ears to deliver sound to the ears.

### SUMMARY

In one aspect, described herein are examples of a composition that include one or more elastomers; and one or more agents; where the composition has water permeability greater than about 20 g/(hr*m²). In some implementations, the water permeability is greater than about 50 g/(hr*m²). The water permeability can be greater than about 100 g/(hr*m²). The water permeability can be greater than about 500 g/(hr*m²).

In some implementations, the agent includes a hydrophilic additive, oleophilic additive, inorganic additive, or an extractable agent.

Examples of agents described herein include Cellulobeads D-30, Pemulen TR-2NF Polymeric Emulsifier, Carbopol 971PNF, Carbopol ETD20202NF, Carbopol 974PNF, Noveon AA1, Nylon 6 (POMP900), and Nylon 10-I2. In some implementations, the agent includes Carbopol 974PNF, Carbopol ETD2020NF, Nylon 6 (POMP900), or Cellulobeads D-30. In some implementations, the agent includes cross-linked polyacrylic acid, polyamide, cross-linked carboxymethylcellulose, cross-linked polyvinyl alcohol, or derivatives thereof. In some implementations, the agent includes polyacrylic acid cross-linked with allyl sucrose, allyl pentaerythritol, or divinyl glycol; or polyacrylic acid with C₁₀₋₃₀ alkyl acrylate cross-linked with allyl pentaerythritol.

In some implementations, the agent includes an inorganic additive such as an alkali metal salt. For example, the alkali metal salt can be NaCl. The alkali metal salt can be a fine powder or macro-crystals.

In some implementations, the agent includes an extractable agent such as water soluble sugar, water soluble polymer, or organic solvent soluble wax. Examples of water soluble polymer include polyvinylpyrrolidone and polyvinyl alcohol. Examples of organic solvent soluble wax include liquid paraffin, mineral oil, and wax micro powder.

The compositions described herein include one or more elastomers. In some implementations, the elastomer includes thermoset rubber, or thermoplastic elastomer. Examples of elastomer include thermoset urethanes, butyl rubbers, nitriles, thermoplastic vulcanizate polypropylene, thermoplastic silicone vulcanizate, styrenic-based thermoplastic elastomers, polynorbornene, interpenetrating polymer networks, silicone, or polyisobutylene. In some implementations, the elastomer includes silicone, polynorbornene, polyisobutylene, thermoplastic vulcanizate polypropylene, or thermoplastic silicone vulcanizate. In some implementations, the elastomer includes Smooth-On DragonSkin 30, Startek's Norsorex, ExxonMobil's Exxpro, PolyOne's 481-116, or Dow Comings TPSiV. [09] In one aspect, provide herein are methods of preparing a composition including one or more elastomers, where the method includes incorporating micropores or macropores in the elastomer using a puncturing apparatus, and where the composition has a water permeability greater than about 20 g/(hr*m²).

In one aspect, provide herein are methods of preparing a composition including one or more elastomers and one or more agents, where the method includes:

(a) adding water to the agent;

(b) mixing the agent of (a) with the elastomer; and

(c) curing the mixture of (b) at ambient conditions and/or at elevated temperatures to remove the water;

wherein the composition has a water permeability greater than about 20 g/(hr*m²).

In some implementations, the agent includes a hydrophilic additive, oleophilic additive, or inorganic additive.

In another aspect, provide herein are methods of preparing a composition including one or more elastomers and one or more extractable agents, where the method includes:

(a) mixing the extractable agent with the elastomer;

(b) curing the mixture of (a) at ambient conditions and/or at elevated temperatures; and

(c) extracting the extractable agent from the mixture of (b);

wherein the extractable agent includes alkali metal salt, water soluble sugar, water soluble polymer, or organic solvent soluble wax; and the composition has a water permeability greater than about 20 g/(hr*m²). In some implementations, the alkali metal salt includes NaCl. In some implementations, the water soluble polymer includes polyvinyl alcohol or polyvinylpyrrolidone.

In one aspect, provided herein are earpieces having tip, retaining legs, body, channel, or a combination thereof made from a composition described herein. For example, the tip of the earpiece can be made from a composition described herein.

In one aspect, this disclosure also provides earpieces having the tip made from a composition including one or more elastomers, where the elastomer has macropores, and the composition has a water permeability greater than about 20 g/(hr*m2). In some implementations, the tip of the earpiece further includes a thin layer of a hygroscopic or hydrophilic material located behind the tip.

In one aspect, this disclosure provides an acoustical device having one or more of its components made from a composition described herein. In some implementations, the component is a cushion of a headphone or a cushion of a loop-shaped structure for wearing around a user's neck.

Any two or more of the features described in this specification, including in this summary section, can be combined to form implementations not specifically described herein. The details of one or more implementations are set forth in the accompanying drawings and the description below. Other features and advantages will be apparent from the description and drawings, and from the claims.

### DESCRIPTION OF THE DRAWINGS

FIG. 1 shows a side view of an exemplary earpiece.

FIG. 2 shows a back view of the earpiece in FIG. 1.

FIG. 3 shows an example of a headphone with an earpiece.

FIG. 4 shows an example of a bar graph of the water permeability of elastomers treated with additives.

FIG. 5 shows an example of a bar graph of the water permeability of elastomers treated with NaCl.

FIG. 6 shows an example of acoustic curves.

FIG. 7 shows an example of a schematic apparatus used for permeability measurements.

### DETAILED DESCRIPTION

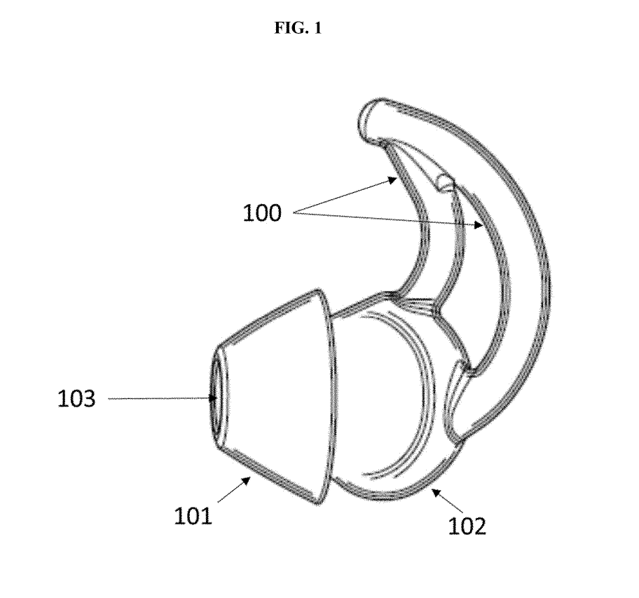

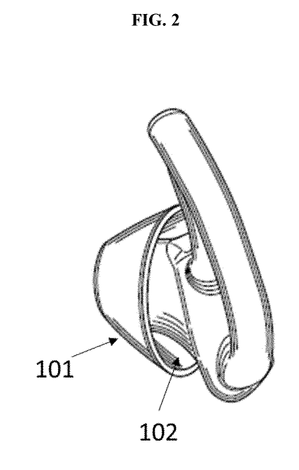

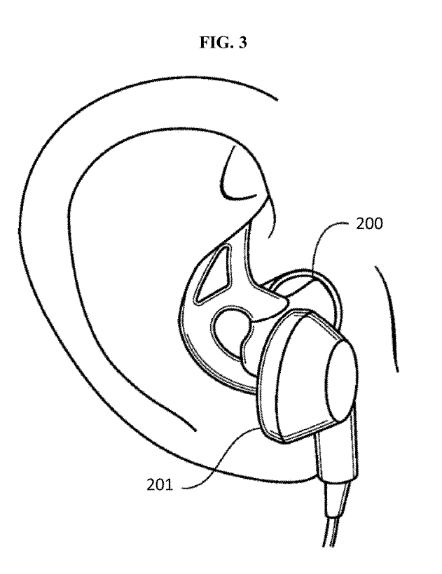

The present disclosure describes compositions that are useful for preparing earpieces. Typically, an earpiece includes a tip that fits into the ear canal, and a retaining structure that is configured to hold the tip in place. FIGS. 1 and 2 provide an exemplary earpiece showing retaining legs 100, tip 101, body 102, and a channel 103 that allows for conducting sound waves. The retaining legs are optional. An earpiece can be configured to be part of a headphone, which typically includes, at minimum, an acoustic driver module. FIG. 3 shows an example of a headphone with an earpiece 200 and acoustic driver module 201. Some earpieces may be connected to an audio generation device wirelessly via a BLUETOOTH® transceiver installed within the earpiece. Some earpieces may serve as passive earplugs that lack any connections or acoustic features. Wearing earpieces can cause discomfort due to build-up of in-ear pressure, heat, moisture, etc. The present disclosure describes earpieces made from compositions that can reduce discomfort to the wearer. As described herein, the left and right earpieces may mirror each other, but have the same structure and function, or a symmetric earpiece may fit either ear.

The disclosure describes compositions for use in earpieces. The compositions have water permeability that allow them to reduce moisture build-up in and around an earpiece wearer's ears and thus, reducing the discomfort due to sweat. As the water permeability increases, the flow of water vapor out of the ears would also increase, making the earpieces more breathable and affording the wearer more comfort. The earpieces made from compositions described herein not only reduce discomfort due to sweat and pressure, the earpieces can also maintain their acoustic properties. The compositions described herein can have water permeability greater than about 20 g/(hr*m²). For example, the water permeability can be greater than about 30, about 40, about 50, about 60, about 70, about 80, about 90, about 100, about 150, about 200, about 250, about 300, about 400, or about 500 g/(hr*m²). The water permeability can be greater than about 50 g/(hr*m²). The water permeability can be greater than about 100 g/(hr*m²). The water permeability can be greater than about 200 g/(hr*m²). The water permeability can be greater than about 500 g/(hr*m²).

The compositions described herein having water permeability greater than about 20 g/(hr*m²) can include one or more elastomers. Examples of elastomer include thermoset rubber and thermoplastic elastomer. The elastomer can be thermoset urethanes, butyl rubbers, nitriles, thermoplastic vulcanizate polypropylene such as EPDM (ethylene propylene diene monomer (M-class) rubber) in polypropylene, thermoplastic silicone vulcanizate (silicone and thermoplastic urethane), styrenic-based thermoplastic elastomers, polynorbornene, ethylene vinyl acetate, interpenetrating polymer networks, silicone, or polyisobutylene. For example, the elastomer is silicone, polynorbornene, polyisobutylene, or thermoplastic vulcanizate polypropylene. In certain implementations, the elastomer can be silicone, platinum cured room temperature vulcanization (RTV) such as Smooth-On DRAGON SKIN® 30, vulcanized polynorbornene such as Startek's NORSOREX®, vulcanized polyisobutylene such as ExxonMobil's EXXPRO™, a TPE such as PolyOne's 481-116, or a thermoplastic vulcanize such as Dow Comings TPSiV®.

The compositions described herein having water permeability greater than about 20 g/(hr*m²) can include one or more elastomers and one or more agents. The agent can increase the water permeability of the elastomer to allow for water vapor build-up to dissipate from inside the ears. Examples of such agent include hydrophilic additive, oleophilic additive, inorganic additive, and an extractable agent. The agents described herein can create water channels such as a percolating network through the elastomer that can make water transport more efficient. For example, a method of preparing a composition described herein can include adding water to the one or more agents (e.g., hydrophilic additive, oleophilic additive, and/or inorganic additive), which can be mixed with one or more elastomer. The resulting mixture can be cured at ambient conditions (e.g., room temperature) and/or at elevated temperatures to remove the water.

The agent described herein can be a cross-linked polyacrylic acid, polyamide, cross-linked carboxymethylcellulose, cross-linked polyvinyl alcohol, or derivatives thereof. For example, the polyacrylic acid can be cross-linked with allyl sucrose, allyl pentaerythritol, or divinyl glycol. The agent can also be a polyacrylic acid with C10-30 alkyl acrylate cross-linked with allyl pentaerythritol. The agent can be Cellulobeads D-30, PEMULENTM TR-2NF Polymeric Emulsifier, CARBOPOL® 971PNF, CARBOPOL® ETD20202NF, CARBOPOL® 974PNF, NOVEON® AA1, Nylon 6 (POMP900), or Nylon 10-I2. Nylon 10-I2 is an odorless, fine white powder that can include microspheres, and the microspheres can include Nylon-12 and isopropyl titanium triisostearate. The agent can be CARBOPOL® 974PNF, CARBOPOL® ETD2020NF, Nylon 6 (POMP900), or Cellulobeads D-30.

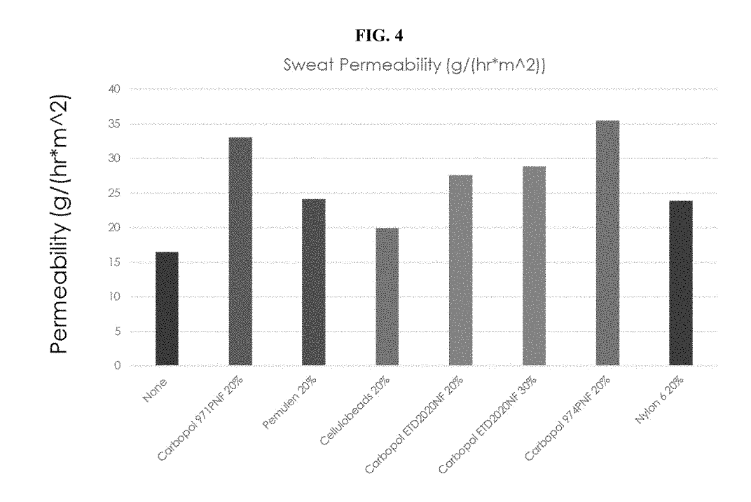

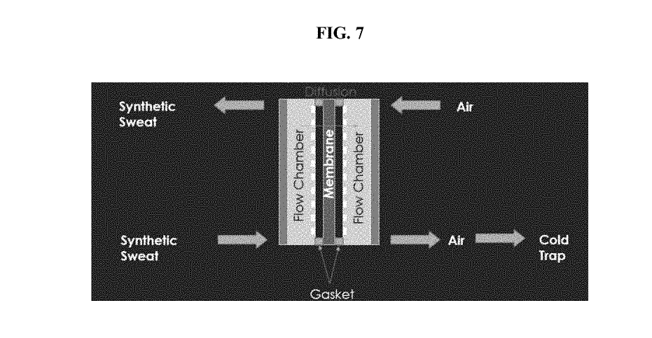

FIG. 4 shows that silicone (Dragon Skin® 30) incorporated with certain additives have increased water or sweat permeability compared to the silicone without such additives. Permeability measurement can be obtained using the ASTM E96 Standard Test Methods for water vapor transmission of material. See FIG. 7 for an example of the schematic apparatus used for the permeability measurement. The synthetic sweat can include water, salt, lactic acid, and urea

Agents such as inorganic additives and extractable agents can be incorporated into the elastomer during the curing process, and the additives can then be extracted from the elastomer with appropriate solvents, leaving channels in the elastomer for water transport. Examples of such agents can include alkali metal salt (e.g., NaCl), water soluble sugar, water soluble polymer (e.g., polyvinyl alcohol and polyvinylpyrrolidone), and organic solvent soluble wax. For instance, a typical method of preparing a composition described herein can include mixing one or more extractable agents with one or more elastomers. The resulting mixture can be cured at ambient conditions (e.g., room temperature) and/or at elevated temperatures. The cured mixture can be treated with appropriate solvents to remove the extractable agents. For example, polar solvents such as water can be used for extraction of PVP (polyvinylpyrrolidone), PVA (polyvinyl alcohol), NaCl (sodium chloride), and sugar. Nonpolar hydrocarbons such as hexane or toluene can be used for extraction of paraffin wax, mineral oil and the like. The size of the water soluble sugar can have a particle size of about 100 microns.

Nonpolar hydrocarbons such as hexane or toluene are used for extraction of paraffin wax, mineral oil and the like.

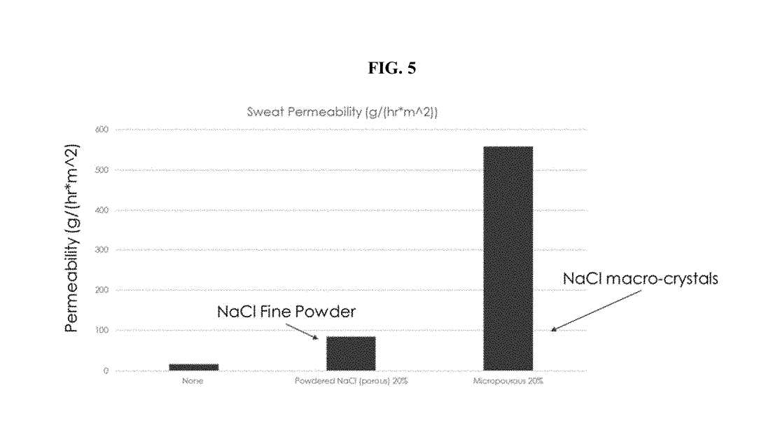

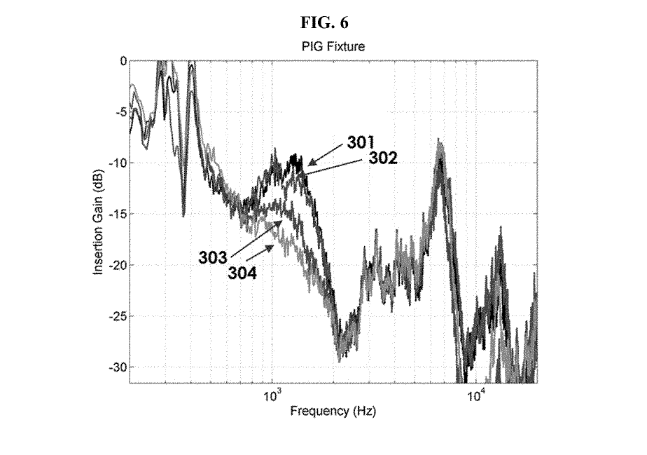

The agent can be an inorganic additive such as an alkali metal salt. The alkali metal salt can be a fine powder or macro-crystals. The particle size of the macro-crystals can be about 100 microns. Examples of alkali metal salt include NaCl. The alkali metal salts can be incorporated into the elastomer prior to curing and then extracted with a solvent to remove the salts, creating water channels in the elastomer. FIG. 5 shows an example of elastomer treated with NaCl fine powder or NaCl macro-crystals. The water or sweat permeability of the sample treated with NaCl macro-crystals has increased compared to the untreated elastomer. Earpieces prepared from elastomers treated with the agents described herein can maintain their acoustic properties. For example, an in-earpiece prepared from a silicone composition that includes porous channels created by NaCl extraction have similar acoustic properties. See for example FIG. 6, where silicone treated with NaCl extraction left earpiece 303 and right earpiece 304 have similar acoustic curves as those of the control samples of silicone left earpiece 301 and right earpiece 302.

Examples of other extractable agents include water soluble sugar, water soluble polymer, or organic solvent soluble wax. Water soluble polymer can be polyvinylpyrrolidone or polyvinyl alcohol. Examples of organic solvent soluble wax include liquid paraffin, mineral oil, and wax micro powder.

Various amounts of the agents can be incorporated into the elastomers. The amount of agents can be about 10% to about 40%, about 10% to about 30%, or about 20% to about 30% by weight. The amount can be about 10% to about 25% by weight. The amount can be about 10%, about 15%, about 20%, about 25%, or about 30% by weight. For example, the amount can be about 20% by weight. Similar amounts of agents can be added to the elastomer prior to curing, which can then be extracted from the cured elastomer using appropriate solvents.

This disclosure also provides compositions of one or more elastomers having micropores. The size of the micropores can be about 10 to about 100 microns. For example, the size of the micropores can be 10 to about 75, about 10 to about 50, about 10 to about 25, about 25 to about 100, about 25 to about 75, about 25 to about 50, about 50 to about 100, about 50 to about 75, or about 75 to about 100 microns. In some examples, the size of the micropores can be less than 75 microns. The size of the micropores can be about 10 to about 75 microns.

A typical method of preparing a composition having one or more elastomers with micropores in the elastomer includes using a micro-puncturing apparatus. An example of such apparatus is the IBeauty Pen 2 Professional automated microneedling device, which has twelve evenly spaced round needle pins (e.g., 33 gauge) made of stainless steel 316 with adjustable lengths from about 0-2.5 mm.

This disclosure also provides compositions of one or more elastomers having macropores to increase permeability of water. However, using elastomers with macropores in earpieces may affect the passive attenuation characteristics of the earpieces. To maintain the passive attenuation of the earpieces, the structure 101 in FIG. 1 and FIG. 2 (the tip) can be made from an elastomer having macropores (e.g., a silicone membrane containing macropores) and a thin layer of material that is hygroscopic or hydrophilic in nature can be included behind the tip 103 (FIG. 2). Examples of such hygroscopic or hydrophilic material include NAFION™ from DuPont; sheet material made from cross-linked polyacrylic acid, polyamide, cross-linked carboxymethylcellulose, cross-linked polyvinyl alcohol, or derivatives thereof; or microporous thin layer of polyethylene terephthalate (PET), Teflon, etc.

Without being limited to certain combinations, an acoustical device can have one or more of its components made from one or more compositions provided herein. The acoustical device can be an earpiece (e.g., in-ear earpiece), where one or more components (e.g., retaining legs, body, tip, and channel) is made from one or more compositions described herein. For example, the tip of the in-ear earpiece can be made from one or more compositions provided in this disclosure. Other examples of an acoustical device include headphones that go over a user's ears or a loop-shaped structure for wearing around a user's neck. The cushion of a headphone or a cushion of a loop-shaped structure for wearing around a user's neck can be made from one or more compositions provided in this disclosure.

As used herein, and unless otherwise specified, the term “about,” when used in connection with a numeric value or range of values is to indicate that the value or range of values may deviate to an extent deemed reasonable to one of ordinary skill in the art. It is well known instrument variation and other factors can affect the numerical values. The term “about” is to accommodate these variations.

What is claimed is:

1. A composition comprising:
one or more elastomers; and
one or more agents;
wherein the composition has water permeability greater than about 20 g/(hr*m²).

2. The composition of claim 1, wherein the water permeability is greater than about 50 g/(hr*m²).

3. The composition of claim 1, wherein the water permeability is greater than about 100 g/(hr*m²).

4. The composition of claim 1, wherein the water permeability is greater than about 500 g/(hr*m²).

5. The composition of claim 1, wherein the agent comprises a hydrophilic additive, oleophilic additive, inorganic additive, or an extractable agent.

6. The composition of claim 1, wherein the agent comprises Cellulobeads D-30, Pemulen TR-2NF Polymeric Emulsifier, Carbopol 971PNF, Carbopol ETD20202NF, Carbopol 974PNF, Noveon AA1, Nylon 6 (POMP900), or Nylon 10-I2.

7. The composition of claim 1, wherein the agent comprises Carbopol 974PNF, Carbopol ETD2020NF, Nylon 6 (POMP900), or Cellulobeads D-30.

8. The composition of claim 1, wherein the agent comprises cross-linked polyacrylic acid, polyamide, cross-linked carboxymethylcellulose, cross-linked polyvinyl alcohol, or derivatives thereof.

9. The composition of claim 1, wherein the agent comprises polyacrylic acid cross-linked with allyl sucrose, allyl pentaerythritol, or divinyl glycol; or polyacrylic acid with C₁₀₋₃₀ alkyl acrylate cross-linked with allyl pentaerythritol.

10. The composition of claim 5, wherein the inorganic additive comprises an alkali metal salt.

11. The composition of claim 10, wherein the alkali metal salt comprises NaCl.

12. The composition of claim 10, wherein the alkali metal salt comprises a fine powder or macro-crystals.

13. The composition of claim 5, wherein the extractable agent comprises water soluble sugar, water soluble polymer, or organic solvent soluble wax.

14. The composition of claim 13, wherein the water soluble polymer comprises polyvinylpyrrolidone or polyvinyl alcohol.

15. The composition of claim 13, wherein the organic solvent soluble wax comprises liquid paraffin, mineral oil, or wax micro powder.

16. The composition of claim 1, wherein the elastomer comprises thermoset rubber or thermoplastic elastomer.

17. The composition of claim 1, wherein the elastomer comprises thermoset urethanes, butyl rubbers, nitriles, thermoplastic vulcanizate polypropylene, thermoplastic silicone vulcanizate, styrenic-based thermoplastic elastomers, polynorbornene, interpenetrating polymer networks, silicone, or polyisobutylene.

18. The composition of claim 1, wherein the elastomer comprises silicone, polynorbornene, polyisobutylene, thermoplastic vulcanizate polypropylene, or thermoplastic silicone vulcanizate.

19. The composition of claim 1, wherein the elastomer comprises Smooth-On DragonSkin 30, Startek's Norsorex, Exxpro, PolyOne's 481-116, or Dow Comings TPSiV.

20. A method of preparing a composition comprising one or more elastomers, comprising incorporating micropores or macropores in the elastomer using a puncturing apparatus, wherein the composition has a water permeability greater than about 20 g/(hr*m²).

21. A method of preparing a composition comprising one or more elastomers and one or more agents, comprising:
(a) adding water to the agent;
(b) mixing the agent of (a) with the elastomer; and
(c) curing the mixture of (b) at ambient conditions and/or at elevated temperatures to remove the water;
wherein the composition has a water permeability greater than about 20 g/(hr*m²).

22. The method of claim 21, wherein the agent comprises a hydrophilic additive, oleophilic additive, or inorganic additive.

23. A method of preparing a composition comprising one or more elastomers and one or more extractable agents comprising:
(a) mixing the extractable agent with the elastomer;
(b) curing the mixture of (a) at ambient conditions and/or at elevated temperatures; and
(c) extracting the extractable agent from the mixture of (b);
wherein the extractable agent comprises alkali metal salt, water soluble sugar, water soluble polymer, or organic solvent soluble wax; and the composition has a water permeability greater than about 20 g/(hr*m²).

24. The method of claim 23, wherein the alkali metal salt comprises NaCl.

25. The method of claim 23, wherein the water soluble polymer comprises polyvinyl alcohol or polyvinylpyrrolidone.

26. An earpiece having tip, retaining legs, body, channel, or a combination thereof made from a composition of claim 1.

27. The earpiece of claim 26, wherein the tip of the earpiece is made from a composition of claim 1.

28. An earpiece having the tip made from a composition comprising one or more elastomers, wherein the elastomer comprises macropores, and wherein the composition has a water permeability greater than about 20 g/(hr*m2).

29. The earpiece of claim 28, wherein the tip further comprises a thin layer of hygroscopic or hydrophilic located behind the tip.

30. An acoustical device having one or more of its components made from a composition of claim 1.

31. The acoustical device of claim 30, wherein the component is a cushion of a headphone or a cushion of a loop-shaped structure for wearing around a user's neck.
